(19) United States
(12) Patent Application Publication
(10) Pub. No.: US 2007/0283319 A1
(43) Pub. Date: Dec. 6, 2007

(54) Software development framework using component-based architecture

(75) Inventors: Stephen Coy, Los Ranchos de Albuquerque, NM (US); Gregory Gershanok, Albuquerque, NM (US); Ali Boroujerdi, Placitas, NM (US); Zane Dodson, Round Rock, TX (US); Robert Praus, Albuquerque, NM (US)

Correspondence Address: Trellis Intellectual Property Law Group, PC, 1900 EMBARCADERO ROAD, SUITE 109, PALO ALTO, CA, 94303, US

(73) Assignee: MZA Associates Corporation, Albuquerque, NM (US)

(21) Appl. No.: 11/732,477

(22) Filed: Apr. 2, 2007

Related U.S. Application Data
(60) Provisional application No. 60/788,581, filed on Apr. 1, 2006.

(51) Int. Cl. G06F 9/44

(52) U.S. Cl. 717/104

(57) ABSTRACT

Reliable signaling between outputs and inputs is provided. Inputs and outputs are allowed to be mutable and thus can change. The change of an output affects inputs connected to it. Thus, when write access is requested for an output, a notification is sent to inputs connected to it. The change may be made and then write access may be released signaling that the change is completed. A notification that the change has been completed is then sent from the output to the inputs. This allows a user to know when exactly the change occurred and ended.

### CROSS REFERENCES TO RELATED APPLICATIONS

This application claims priority from U.S. Provisional Patent Application Ser. No. 60/788,581, entitled SOFTWARE DEVELOPMENT FRAMEWORK USING COMPONENT-BASED ARCHITECTURE, filed on Apr. 1, 2006, which is hereby incorporated by reference as if set forth in full in this application for all purposes.

### ACKNOWLEDGMENT OF GOVERNMENT SUPPORT

This invention was made with Government support awarded by the United States Missile Defense Agency under contract number F29601-03-C-0186. The Government may have certain rights in this invention.

### COPYRIGHT DISCLAIMER

A portion of the disclosure recited in this application contains material which is subject to copyright protection. Specifically, computer program listings, source code or other types of functional text are included. The Applicant has no objection to the facsimile reproduction of the functional text in which Applicant may have copyright protection, otherwise of Applicant's copyright rights are reserved. Some of the provided source code, such as library routines, compiler modules, etc., may be owned or controlled by a third party other than the Applicant. Applicant makes no claim or disclaimer to such third party source code.

### COMPUTER PROGRAM LISTING APPENDIX

A computer program listing appendix is provided on one CD-ROM with this application. The information on the CD-ROM is hereby incorporated by reference as if set forth in full in this application for all purposes. The CD-ROM is provided in duplicate. Details of the contents of the CD-ROM are provided starting at paragraph [88]. A list of the files on the CD-ROM is included in Table I, below. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text, otherwise all copyright rights are reserved.

### BACKGROUND

Software development for complex systems is expensive and time-consuming. Many attempts have been made to improve on both of these fronts, such as by providing programmers with pre-made components, libraries, development environments, tools, and other assets.

One area in which software development assets are being used to develop complex software is in simulation and modeling. Simulation and modeling applications can be adaptable to pre-made assets since different applications often require the same, or similar, processing objects, simulation algorithms, input/output and other components or functionality. Simulation tools and languages such as Simulink™ by MathWorks™; SystemBuild™, Easy5™ and ACSLXtreme™ are among those that have traditionally been available to programmers in order to allow more efficient creation of simulation and modeling applications.

Invariably, pre-made tools or languages have had to compromise on flexibility and optimization in order to provide cost and time savings. For example, by using pre-made components a programmer or designer can more quickly piece together a desired simulation but often the resulting system is not exactly according to design requirements. The resulting system may not provide all of the functionality desired or may not perform as quickly or as accurately as would be possible had the system been coded from scratch. With some tools, a feasible design may not be possible at all with off-the-shelf tools as, for example, when pre-made objects are not suitable to simulate a desired aspect of the design.

During simulation, changes to inputs and output may be performed. In this case, write access may affect the value of an output thus affecting inputs connected to the output. The inputs may be warned that the output will change. The change is made and sometime after the change, the simulation is resumed. The outputs know that a change was made but in the time that the output was changed, many other outputs connected to an input may have also been changed (and many warnings may be received that changes are being made). In large-scale systems, this may often be the case. Thus, it may not be possible to isolate the changes that are made.

### SUMMARY

Particular embodiments provide a software development framework that uses a component-based architecture. Various types of software systems, including modeling and simulation, can be produced with a base underlying object architecture and a user interface for manipulating the objects and other components and aspects of a system.

In one embodiment, functionality is provided in an object oriented programming (OOP) class library. All major classes of the library are derived from a single base class. An object model allows generalized objects that include standard OOP type objects, time-varying characteristics and virtual objects. With this framework various features as described herein are provided.

In a graphical user interface system objects are represented as system icons or images on a display screen. Interconnections between system icons are shown by connection lines. The connection lines correspond to instances of input and output object classes which are derived from an object model that defines an actively self-descriptive object-valued function of virtual time, that is, a software object which describes a function of time whose value at any moment in virtual time (a kind of pseudotime defined by the software framework) can be represented by the instantaneous state of some (other) software object, and which provides reliable signaling of all discrete changes (i.e. changes that occur without any change in virtual time), by providing first a warning immediately before the change begins, followed by a notification immediately afterward. In addition, an actively self-descriptive function of virtual time would generally provide access to information describing the type of software object used to represent its value, except in the case of an embodiment where that information is already provided by the computer language used. If the type used to represent the value changes, that would be treated as a discrete change, and signaled with a warning before and a notification afterward. In the case of an embodiment that supports modeling or representation of continuous-time processes an actively self-descriptive function of virtual time should provide a mechanism whereby users can determine whether or not that particular function varies continuously with time or not. If the function changes from varying piecewise continuous changes to not doing so, or vice versa, that would be treated as a discrete change, and signaled with a warning before and a notification afterward.

Reliable signaling between outputs and inputs is provided. Inputs and outputs are allowed to be mutable. A mutable input or output allows read/write access to the input or output. For example, a system with a mutable input can obtain read-write access to the input value, and therefore can modify it. Similarly, a mutable output permits read-write access to systems with connected inputs, while a non-mutable output permits only read access. A change of an output affects inputs connected to it. Thus, when write access is requested for an output, a notification is sent to inputs connected to it. The value of the output can then be read by a system with a connecting input. The change may be made and then write access may be released, which signals that the change is completed. A notification that the change has been completed is then sent from the output to the inputs. The value of the changed output may then be read by the system. This allows a user to know when exactly the change occurred and ended, and also to know the values before the change and after.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows an example of an interface according to one embodiment.

FIG. 2 depicts a simplified flowchart of a method for providing reliable signaling of output changes according to one embodiment.

FIG. 3 shows another example of interface for providing read access according to one embodiment.

FIG. 4 shows another example of the interface for providing write access to an output according to one embodiment.

FIG. 5 depicts a simplified flowchart of a method for modifying inputs according to one embodiment.

FIG. 6 depicts a simplified block diagram of a computer system according to an embodiment of the present invention.

### DETAILED DESCRIPTION OF EMBODIMENTS

Particular embodiments provide a framework for software design including systems simulation and modeling. It employs a local object model (intraprocess) and also provides integrated support for distributed processing (interprocess). The framework provided by particular embodiments provides objects that are derived from a base class, tSystems. Objects can have their own data members and member functions in addition to their inputs and outputs. Ordinarily only the inputs and outputs are used for defining relationships between tSystems, while data members and member functions are used to define systems' internal state representations and behavior. In some embodiments it may be useful to allow inputs and outputs to be paired or grouped, so that all members of the pair or group must be connected simultaneously to a complimentary pair or group.

In one embodiment, the required core functionality is provided by an OOP class library. The C++ programming language is used but any suitable language and software design can be employed. All classes in the library, with the exception of a few minor helper classes, are derived from a single base class, tObject. All tObjects within the same process form a well-defined containership hierarchy. Other classes in the library include tSystem, and tVariable, both of which are derived from the class tObject, and tInput and tOutput, both of which are derived from the class tVariable. In each case the name of the class, apart from the prefix “t”, has been chosen to reflect the purpose and function of the class. For example, the class tSystem is designed to represent the basic concept of a system, as the term is commonly used by a person skilled in the art. The class tVariable is designed to represent a “variable”, that is a time-varying quantity or object. The class tInput is designed to represent an “input” of a system, which is a variable outside the system that is visible to the system and may affect its time evolution. The class tOutput is designed to represent an “output” of a system, that is a variable inside the system that is visible outside the system and may affect the time evolution of objects external to the system. In the disclosure, terms with a “t” before them may be referred with the “t” or without. For example, tOutput may be referred to as an output.

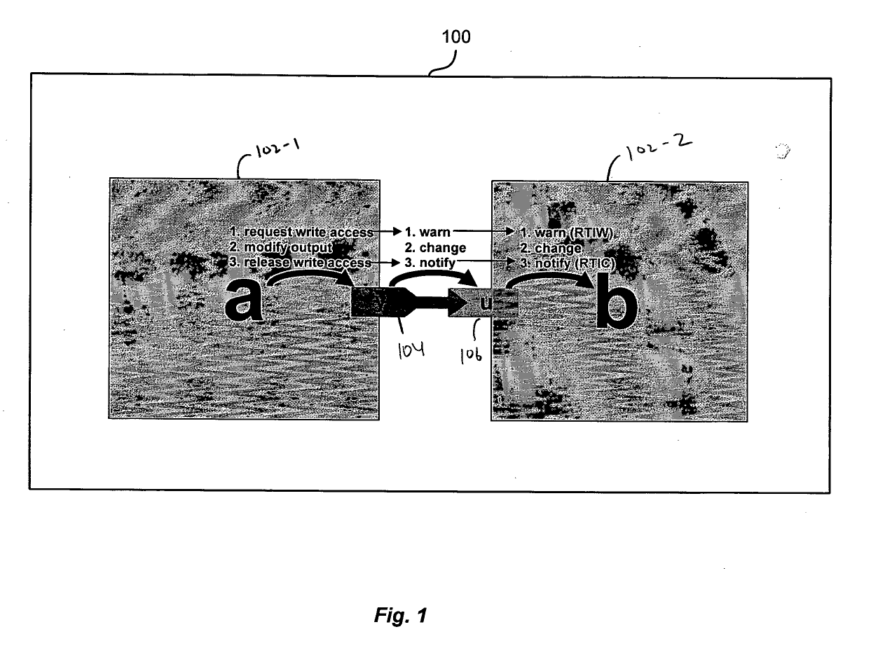

FIG. 1 shows an example of an interface 100 according to one embodiment. As shown, a tSystem 102-1 (labeled system a) and tSystem 102-2 (labeled system b) are provided. tSystem 102-1 includes a tOutput 104 (labeled output y) and tSystem 102-2 includes a tInput 106 (labeled output u). tOutput 104 is connected to tInput 106.

tOutput 104 and tInput 106 may be tVariables from a class tObject. A tVariable may be a variable that can be constant or can be changed. The class tObject also defines interfaces needed to support various forms of pervasive functionality such as persistence, reflection, and a command-based interface supporting undo/redo. All mutating operations on tObjects go through the command-based interface 100; this is required for undo/redo and useful for reflection. Note that in other embodiments it may not be necessary to have all or even most of the classes derived from a single base class in order to achieve the features and benefits of particular embodiments.

Inputs and outputs are mapped into the classes: tSystem 102, tInput 106, and tOutput 104. Each different type of component (called a “tSystem” or “system”) is implemented by a different class derived from the class tSystem (called a “system class”) and each tSystem's external interface is defined by a set of tInputs and tOutputs (called its “inputs” and “outputs”). Larger systems can be composed from (or decomposed into) smaller systems (subsystems) by connecting the subsystems inputs and output to one another, and to the inputs and outputs of the larger system.

A tSystem's set of inputs and outputs is not fixed; inputs and outputs can be added and deleted dynamically. Classes tInput and tOutput are both derived from the class tVariable. tVariable defines an interface for an actively self-descriptive object-valued function of virtual time. An “object-valued function” includes a function whose instantaneous value is defined by the instantaneous state of some OOP object. The object defining the tVariable's value can be of any legal type (any legal C++ type, in the present implementation), including use-defined types, i.e. classes.

The same tVariable's value may at different times be represented by different objects, possibly of different types. There is no requirement that the value-defining object must exist at all, until and unless someone asks the tVariable for its value.

“Virtual time” is represented as having two components, a real-valued part representing a notion of time, and a discrete part used to keep track of the actual order of execution of discrete events occurring at the same real-valued virtual time. In the most general case the functions in the framework are piecewise continuous, where any “continuous” variation with respect to virtual time is simulated. Other variations on time based functions are possible such as piecewise constant, etc.

tInput 106 and tOutput 104 may be considered tVariables. tVariables report on changes to their functions or other characteristics. For example, before each discrete change to the value of the function, the tVariable sends a warning to anyone interested. For example, warnings or messages are sent to any other tVariable connected to the first tVariable via a tDependency, and also, in the special case of a tInput, to the tSystem to which it belongs. After all warnings have been sent, then the discrete change is allowed to proceed. Finally, the tVariable then sends a notification to each after the discrete change has been completed. Also, any tVariable, given sufficient advance notice, will provide access not only to its present value, but also to its past time history. This past time history reporting ability, also called “recallability,” can go back to the moment advance notice was given, or back to some specified maximum time interval. Thus, a user can determine when the changes were made and what was changed. In one embodiment, recallability records a snapshot of the value (or state) of the tVariable before and/or after each discrete change, relying upon the change-signaling mechanism (i.e. warnings and notifications) in order to reliably detect each discrete change. In another embodiment, which is useful for tVariables of types that support a command-based interface, takes snapshots of the tVariable value only occasionally, and in between record the sequence of commands applied to that tObject. In certain cases, as when the tVariable represents an object that may be coupled (e.g. via pointers or references) to many other objects, it may be necessary or desirable to record simultaneous snapshots of the states of many objects in order to ensure that the state of the tVariable can later be recalled, because its state may depend in part on the states of the other objects to which it is coupled. In order to reliably determine which other objects may need to be recorded, the tObject containership hierarchy may be used and all interactions between objects that cross containership boundaries go through explicit connections implemented by the class tDependency and classes derived from it, which can then be made visible to the mechanisms used to support recallability. By tracing these dependencies which subset of the tObject hierarchy that is needed to take snapshots of to support recallability for a given tVariable may be determined. Another embodiment takes snapshots of the entire tObject hierarchy before and after each change. In the case of tVariables whose value can vary continuously in time, to support recallability it may be necessary or desirable to take and record snapshots of the internal state of the solver or solvers used. A solver is a mechanism used for the numerical solution of equations that describe continuous-time and/or hybrid (continuous and discrete) processes, and interactions between them. Different kinds of solvers are used to address different kinds of equations, ordinary differential equations, “stiff” or non-stiff sets of equations, partial differential equations, differential-algebraic equations, or delay differential equations.

tVariables can be either const (the default) meaning that they provide read-only access to the value-defining object, or mutable, meaning that they can provide read-write access. tVariables can be either single (the default), meaning that they represent a single object-valued function of time, or multi, meaning that they represent multiple object-valued functions of time. For example, tOutput 104 and tInput 106 may be objects in the component-based software framework. In one example, tOutput 104 and tInput 106 may be non-mutable inputs and outputs. This means that the inputs and outputs may be read-only. Also, mutable inputs and outputs may be write/read.

tVariables may also be variables other than inputs and outputs, such as tWrapper, tProxy, and tEnvironmentVariable. tWrapper can be used to “wrap” essentially any self-contained OOP object, turning it into a tObject. tWrapper traps requests for write-access to the underlying OOP object, allowing it to issue a warning before access is granted and a notification afterward. tProxy is a tVariable whose value is identified with that of some other tVariable, called its subject, e.g. a tWrapper or another tProxy. tInput 106 and tOutput 104 are both derived from tProxy. tEnvironmentVariable is a special tProxy designed for use in cases where many tSystems at various levels of the containership hierarchy may need access to the same tVariable, and the system designer(s) prefers not to have to add corresponding inputs and connect them up. A tEnvironmentVariable plays a role analogous to a tInput, except that instead of being explicitly connected to its subject, like a tInput to a tOutput, its subject is instead located via a recursive upward name-based search through the containership hierarchy.

System classes can be used to implement virtually any imaginable causal relationships between their inputs, their internal state, and their outputs. A system's internal state can be represented in any way the system class designer finds convenient, from simple data members to complex dynamic object structures. The relationships between a system class' inputs, internal state, and outputs are defined by its member functions. The class tSystem defines a number of virtual functions which the system class designer can override to define how the system responds to stimuli such as changes to its inputs or requests for its outputs. For example, the virtual functions that may be used include functions that may be called to notify tSystems of changes to outputs. For example, a respondToInputWarning function may be called to send a warning that write access to a connected output has been requested. The tSystem then has the option of requesting read access to the value of the output. The function respondToInputChange may be called to send a message that write access has been released. The tSystem then has the option of requesting read access to the value of the output. Thus, the tSystem can determine the value of the output before the change and after the change. Also, the function respondToOutputRequest sends a message that read access to an input has been requested. In addition, the system designer can define whatever other member functions he may need to implement the desired functionality for the component.

It is possible for two or more changes to occur to the value of the same tVariable at the same virtual time, and it is also possible that after one change has begun a second change will begin before the first has completed. In a multi-threaded environment this can occur whenever two or more threads perform a mutating operation on the value of the same tVariable at the same time. In a single-threaded environment this can happen when one mutating operation triggers another, e.g. in a series of function calls, and eventually that series loops back to operate on the same object a second time. In either case reliable signaling can be provided of the beginning and ending of each change by detecting requests and releases of write-access. In a multi-threaded environment changes can overlap one another, one change may begin, then a second begins, then the first ends, then the second ends. In the single-threaded case, if we require each request for write access and the corresponding release of write access occur within the same scope, then any events which overlap in time will automatically be nested; that is, if while one event is in progress a second event begins, then the second event must be completed before the first event is completed. In some cases a user may be interested to know every detail about any changes affecting an input, including nested and/or overlapping changes. In other cases the user may only be interested in the net changes that result, independent of whatever nested and/or overlapping changes may have been involved. In one embodiment, designed for a single-threaded environment, particular embodiments support both kinds of interfaces, one providing warnings and notifications for all changes, nested or not, and one that provides warnings and notifications only for top-level (non-nested) changes.

A tSystem can contain other tSystems (as well as tObjects of other kinds) and at the same time it can also have behaviors defined in other code. Because of this, it is not necessary to make any particular distinction between atomic and composite systems. This approach is useful, for example, for implementing self-modifying component-based software systems. Subsystems behaviors in can be input-driven, output-driven, event-driven, or any combination of the above or triggered, controlled or derived from other signals or conditions. Systems can schedule events of any number of distinguishable event types, each optionally carrying event-specific information (e.g. a message to be delivered after a delay), and events can be scheduled, canceled, and rescheduled as necessary to implement the desired behavior. Continuous-time behaviors are supported which can be combined with input-driven, output-driven, and event-driven behaviors. For example, a camera model might schedule discrete events such as shutter open and shutter close, but then respond continuously to changes to the light impinging on it while its shutter is open.

The software framework provides a mechanism called affector-affectee connections used to explicitly indicate temporal relationships between tVariables, used to (1) automatically forward warnings and notifications where appropriate, (2) map recallability requirements from tVariable to tVariable, taking into account delays, (3) detect and algebraic loops (a closed loop of zero-delay dependencies, analogous to a short-circuit), and (4) when modeling continuous-time interactions, decomposing the full set of continuously coupled systems into a directed acyclic graph of sets of mutually continuously coupled systems (this has significant efficiency implications).

A tSystem's internal state representation and behavior are not fixed, even though in one embodiment they are defined by compiled C++ source code. To support runtime modification of the internal state representation and behavior of tSystems keeps track of the source code for each system class, making it available on demand to users for editing, and then recompiles the code into a new DLL, links to it, instantiates the modified class, swaps the new tSystem in place of the old tSystem, and then deletes the old one. In one embodiment, a different name is used each time a class is modified. The name is obtained by appending a timestamp onto the user-specified class name.

Any tObject will, upon request, provide a self-representation or selfRep, a tVariable whose instantaneous value is defined by the instantaneous state of that tObject. In general, every tObject (including tSystems) is contained within some tUniverse, where tUniverse is a class used to represent the concept of a virtual universe. tUniverse is the only exception; tUniverses can be contained within other tUniverses, but they need not be. tUniverse maintains a consistent representation of virtual time for all objects contained within it, and coordinates the advance of virtual time (whenever we choose to advance virtual time) for all tObjects contained within it.

tUniverse provides an event-scheduling/dispatching mechanism with an integrated facility for modeling continuous-time phenomena in between discrete events. Events are time-delayed commands, handled by the tObject command interface. tUniverse also provides a consistent representation of space for all tObjects contained within it. This basically involves defining the root for a tree of coordinate frames used to define the (virtual) positions, extents, orientations, velocities, angular velocities, accelerations, and angular accelerations of real or hypothetical physical objects represented by tObjects.

tObjects typically interact only with other tObjects within the same tUniverse, but two mechanisms are supported that make it possible to cause tObjects from different tUniverses to interact with one another. The two tUniverses need not necessarily be within the same process, or on the same device. The first mechanism is designed to make it possible for a tProxy and its subject to reside within different tUniverses: within the containership scope of the tProxy a local proxy object is used to represent the remote subject, and within the containership scope of the subject a local proxy object is used to represent the remote tProxy. These two proxy objects are used to hide all the details of the communication. The second mechanism is designed to make it possible to create local copies of remote tObjects, reproducing their behavior and internal state and structure, in whole or in part.

Objects are organized into systems and subsystems. Each different kind of subsystem is implemented as a subclass of a common base class (the class “tSystem” in a current embodiment). Parameters are implemented as constructor arguments. These classes can use whatever form of internal state representation the subsystem designer finds convenient—data members, dynamic data structures, etc. Inputs and outputs are distinct objects (as opposed to having one input vector and one output vector), a system can have any number of inputs and outputs, and each input or output can be of any defined OOP type (i.e. C++ type in the present implementation), including user-defined types as opposed to always being real-valued or chosen from among some limited set of supported types as in various prior art tools. Similarly, parameters can be of any defined OOP type, including user-defined types. Inputs and outputs whose values can vary continuously with time may also be of any defined type, including user-defined type, provided that that type can exhibit some form of continuous-time variation. This makes it possible, for example, to custom design special types to be used to represent specific kinds of continuous-time interactions, such as optical or mechanical interfaces.

tSystem 102 is notified whenever any of its inputs change, giving it a chance to respond to the change, and whenever any its outputs is specifically requested, giving it the opportunity to make sure that the output value/state is up to date. Other embodiments can use different approaches to notification, including notification that does not occur all of the time. A subsystem designer has the option of deferring re-computation of an output value until it is requested. Both individual warnings and individual notifications can be sent reflecting the precise order of initiation and completion of mutating operations, and, whenever available, a precise description of the nature of each change is also available.

For example, referring to FIG. 1, at some point, a request for write access to tOutput may be received. When write access is requested, a warning may be sent to input 106 of tSystem 102-2. The warning may provide a notice that an output connected to an input is about to change. Then, appropriate responses to the change may be determined, such as requesting read access to tOutput 104.

tOutput 104 may then be modified. For example, tSystem 102-1 may modify values that are output. tVariables, e.g. tInputs or tOutputs, may be used to represent functions of time which in some cases may vary only discretely and in other cases may be subject to continuous-time variation as well. When the variation is discrete-only, every change in value is signaled individually. For example, the modification may occur once. When a change occurs, tOutput 104 informs tInput 106 of the change. tSystem 102-2 can then read the change. When the variation is continuous, the value of the function represented by the tVariable in principle assumes an infinite number of values within a finite time. It is not possible to signal each of these infinitely many changes individually. Rather, a warning and notification may be sent only after discrete changes, i.e. changes that occur with no change in virtual time. Also the warning and notification may be sent when a tVariable's value changes from varying continuously to varying only discretely, which is regarded as a discrete change and is therefore signaled explicitly with a warning-before and a notification-after.

Values of inputs and outputs may be passed by reference. This approach can be more efficient for large objects, as compared to other methods such as pass-by-value, which involves making a copy of the object passed. Passing by reference also makes it possible to use input-output connections to define persistent relationships between complex objects that cannot be meaningfully passed by value, because their “value”, i.e. state, is defined in part by the context in which they exist, that is their interrelationships with other external objects. Types of the underlying object need not exactly match the declared output type, so long as there is a defined type conversion; this means one can, for example, define a relatively generic type for use in ensuring compatible interfaces when establishing connections, but then use a specialized subclass to implement the specific desired behavior. Various embodiments can use other parameter passing techniques and can also mix techniques, as desired.

After making the change, tSystem 102-1 may release the write access. This indicates that the change has been completed. tOutput 104 then notifies tInput 106 that a change has been completed. tSystem 102-2 may then request read access to output 104 to read the changed value.

Notifying that the change has been complete or that write access has been released allows a user to determine what changes were made. Conventionally, tSystem 102-2 may be warned that tOutput 104 was being changed. However, there was no strict notification that the change has been completed. Rather, it was assumed the change was performed when virtual time was allowed to advance. But, during this time, other changes may have been made to other outputs that affect tInput 106. Thus, a user cannot conventionally know which changes were made. However, in particular embodiments, tInput 106 is notified that write access has been released and thus the change has been completed. A message may be recorded when this notification is received and the value is stored. Thus a user can see what change has been made from when the write access was requested to when it was released.

In one embodiment, different ways to determine when write access is released may be used. In one embodiment, a smart pointer may be used to determine when write access is released. When a tSystem 102 requests write access, a smart pointer may be created. The smart pointer is then assigned to an object, such as tOutput 104 and is needed to access the object. Thus, tOutput 104 may be accessed and modified. When the modifications are finished, then access is released. The smart pointer is configured to release write access when it is deleted. Thus, tSystem 102 is able to determine when the change to tOutput 104 is finished. This provides an efficient method for determining when write access is released.

Another method may be that a method is added in code that notifies tSystem 102 that write access has been released. However, this relies on a user to add the method and call it when it finishes performing the change. In some cases, users may forget to do this. Accordingly, a smart pointer that is required to access an object may be better.

Also, a smart pointer may be used when read access is requested. When a tSystem 102 requests read access, a smart pointer may be created. The smart pointer is then assigned to an object, such as tOutput 104. The smart pointer is needed to access the object to read a value. The smart pointer is configured to be release read access when it is deleted.

Allowing looking back in time by accessing past values and time histories of tOutputs 106 (and other tVariables) makes it easier to implement causal relationships involving time delays, e.g. propagation of light waves or sound waves across some distance. Implementation of virtual time includes both a real-valued part, and a part used to keep track of exactly where in the event sequence for a given real-valued virtual time a given event begins and ends, taking into account the fact that events can be nested inside one another.

The nesting may be very useful for a user. Affector-Affectee connections, used to indicate causal/temporal relationships between tVariables, especially the inputs 106 and outputs 104 of the same system, allow using a network formed by tVariables and Affector-Affectee connections to trace causal dependencies and recallability requirements, and automatically forward warnings and notifications where appropriate. A containership hierarchy provides unambiguous definition for what lies inside any given object, and therefore is considered part of its internal state, e.g. for purposes of change-signaling, as opposed to what lies outside that object. This approach also provides an unambiguous notion of location, with respect to the containership hierarchy, for every object.

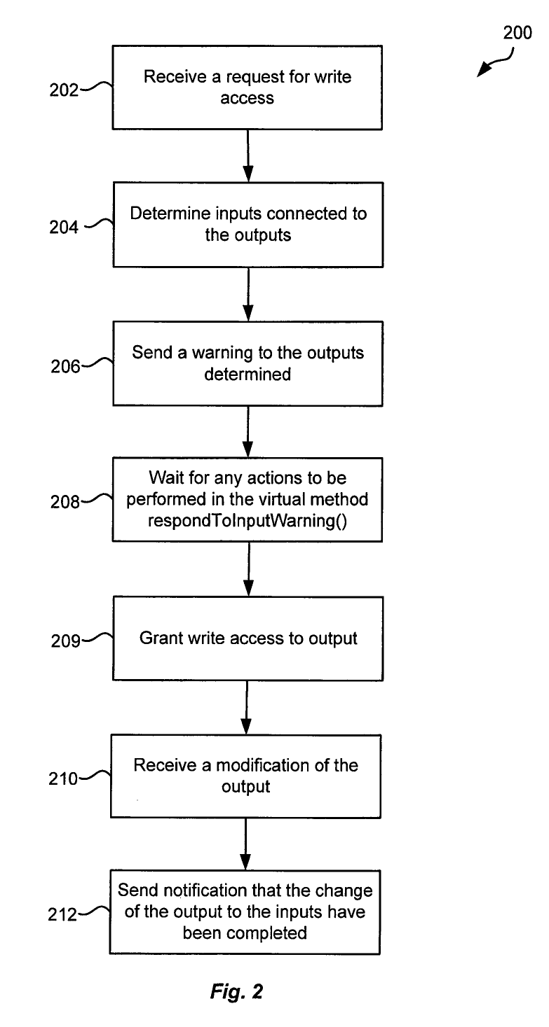

FIG. 2 depicts a simplified flowchart 200 of a method for providing reliable signaling of output changes according to one embodiment. Step 202 receives a request for write access. For example, tSystem 102-1 may request write access to tOutput 104. In one example, tSystem 102-1 may come to a point in its logic where tOutput 104 needs to be modified. tSystem 102-1 requests write access by calling a method that calls a smart pointer (e.g., getMutPtr( )). The method determines if a smart pointer has already been created for the output. If one has, then the same smart pointer may be used. If not, a smart pointer is returned.

Step 204 determines inputs connected to the outputs. For example, multiple inputs may be connected to an output of a tSystem 102-1. All of these inputs may be warned. Thus, step 206 sends a warning to the outputs determined. The warning indicates that a write access has been requested. The method getMutPtr( ) may call the virtual method respondToInputWarning( ) to send warnings to any systems that have connected inputs to the output. A virtual method may be any process that performs some action and which is executed under certain specified circumstances. The virtual method may be called as virtual time is stopped. The calling of the virtual method may not allow any changes to output 104 while the method is being called or active. At this point, any systems have the option of requesting read access to the input before it is changed.

Step 208 waits for any actions to be performed in the virtual method respondToInputWarning( ). For example, tSystem 102-2 may request read access to tOutput 104 and read the current value of the output. When the method returns, output 104 may be modified.

Step 209 grants write access to output 104. Step 210 receives a modification of output 104. For example, when getMutPtr( ) returns, write access is granted. The smart pointer may be used to access and modify output 104. For example, the variable called by the smart pointer may be modified, which modifies output 104. When tSystem 102-1 is finished modifying output 104, the method called by the smart pointer is exited. A deconstructor for the smart pointer is then called.

Step 212 then sends notification that the change of the output to the inputs have been completed. For example, the deconstructor called sends the notification by calling the virtual method respondToInputChange( ). The deconstructor exits and then read access is then available for any systems connected to the output. When the virtual method respondToInputChange( ) returns, then read access is released. Additional changes may now be made to output 104. Thus, while the virtual method respondToInputChange( ) is called to warn of a change that has been completed, the just changed value is available for read access. Thus, a tSystem 102 can reliably know when a value of output 104 has changed because a notification is sent and further changes cannot occur until the virtual method is released.

Read access may also be provided where it is ensured that an output is up to date. For example, tSystem 102-2 may request read access for tOutput 104. tInput 106 may send a read access request to tOutput 104. tSystem 102-1 then ensures that the output is up to date. A message may be generated that is a respond to output request (RTOR). tSystem 102-1 then grants read access and this is signaled from tOutput 104 to tInput 106. tSystem 102-2 can then access the output of tOutput 104.

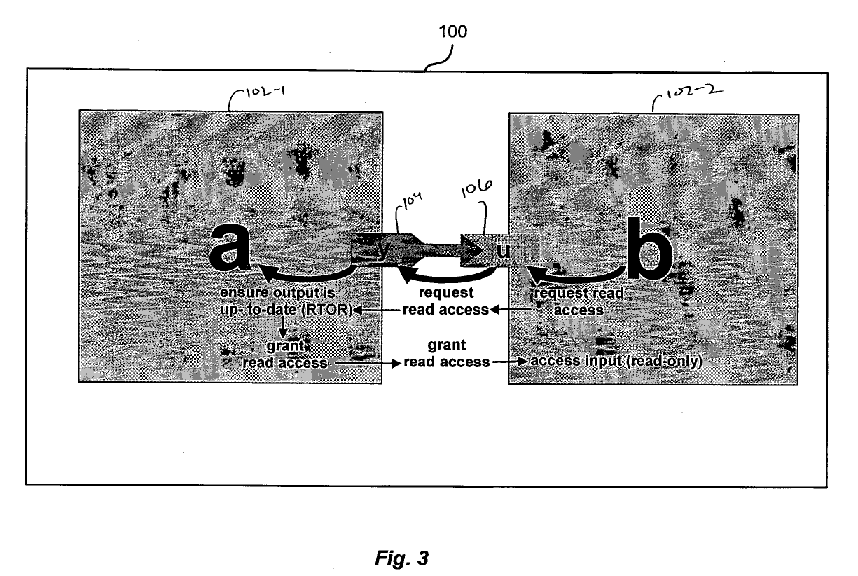

FIG. 3 shows another example of interface 100 for providing read access according to one embodiment. tSystem 102-1 ensures that output 104 is up to date when read access is requested for input 106.

At a point in its logic, tSystem 102-2 determines it needs to read the value of input 106. For example, tSystem 102-2 may want to read the value of input 106 when a respondToInputWarning or respondToInputChange virtual method or some other function is called.

System 102-2 requests read access by calling a method, such as a get( ) or getPtr( ). Inside the method, input 106 determines which output 104 is connected to it and requests read access to its value.

Before output 104 grants read access, it first calls tSystem 102-1 to which it belongs with the virtual method respondToOutputRequest( ). This gives tSystem 102-1 an opportunity to update the value of its output in case it is not already up to date.

Output 104 then grants read access to the input 106, returning a pointer or reference to an object holding the up-to-date value. Input 106 then grants read access to the tSystem 102-2, returning a pointer or reference to that same object. tSystem 102-2 can then read the value of output 104.

In another embodiment, a smart pointer may be used to grant read access. The smart pointer. A value for a variable for output 104 is read. When the method for the smart pointer is exited, then read access is relinquished.

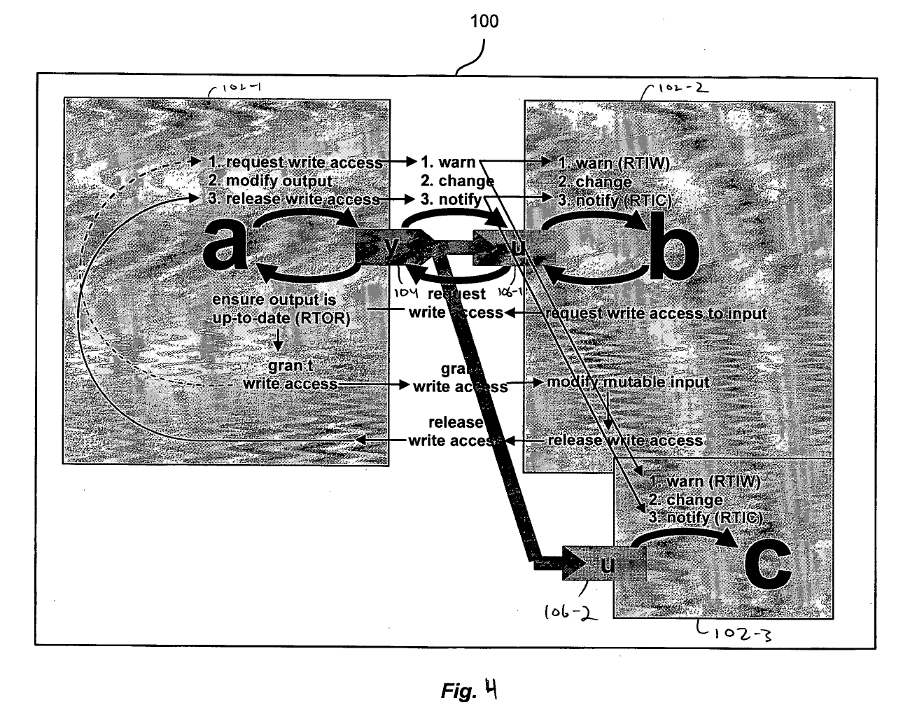

FIG. 4 shows another example of interface 100 for providing write access to an output 106 according to one embodiment. Inputs and outputs may be mutable in the component-based software framework. Mutable inputs and outputs allow read/write access. When a tSystem 102 has a mutable input, that means that tSystem 102 may need to obtain write access to that input 106 at some point. When a tSystem 102 has a mutable output, that means that tSystem 102 is so designed that it can safely grant write access to that output 104 to other tSystems 102. Mutable inputs and outputs may be used when there is some shared resource, e.g. a database, that multiple tSystems 102 need to be able to use, and where their use of that resource, e.g. adding items to the database, may modify its state.

In this case, a tSystem 102 may request write access to a tInput 106. This may cause changes to tOutput 104 and thus, other inputs that are connected to tOutput 104 should also be notified that write access has been granted and that the output has been changed that may affect tInput 106.

System 102-2 arrives at a point in its logic (either in one of its respondTo-virtual methods or else in some other member function) where it needs to modify the value its mutable input 106-1. System 102-2 requests write access to input 106-1 by calling a method, such as getMutPtr( ). Inside system 102-2, input 106-1 determines what output 104 it is connected to, namely input 104 of tSystem 102-1, and requests write access to its value.

Output 104 then checks if there already exists a mutable smart pointer to the underlying object holding the value of a tVariable; if so it returns a “NULL” pointer, to ensure that there exists at most one mutable smart pointer to a given tVariable's value at any given time. For discussion purposes, it is assumed there is not and a non-NULL pointer is returned.

tSystem 102-1 then ensures that the output is up to date. For example, inside the method getMutPtr, tSystem 102-1 is called with the virtual method respondToOutputRequest( ), which gives tSystem 102-1 an opportunity to update the value of its output 104 in case it is not already up to date.

Other inputs 106 connected to output 104 may also be warned that inputs may be changed. For example, before the call to getMutPtr( ) returns, it ensures that a warning is sent to any tSystems 102 with inputs 106 connected to output 104 by calling the virtual method respondToInputWarning( ). In this case it sends a warning back to system 102-2 warning it that its input 106 is about to change. At that point the system 102-2 has the option of obtaining read access to its input 106 before the change occurs. In other embodiments, the warning and notification back to the system that sent the write access request may be suppressed. However, other tSystems 102, such as tSystem 102-3, connected to that same input 106 receive the warnings and notifications.

The process of warning tSystem 102-2 and tSystem 102-3 is similar to the process described with respect to FIGS. 1 and 2. Basically, tSystems 102-2 and 102-3 are warned that write access has been requested. tSystems 102-2 and 102-3 have the option of requesting read access to output 104.

Then, a smart pointer is used to modify the value of output 104, and then the same smart pointer can be used by system 102-2 to modify output 104. For example, tSystem 102-2 can modify the underlying object holding the value of its mutable input 106. (This is the same object that holds the value of output 104 of tSystem 102-1.).

When tSystem 102-2 is finished modifying the value of output 106, write access is released. For example, tSystem 102-2 exits the scope in which the smart pointer used to convey write access, at which point its destructor is called. Inside that destructor, all tSystems 102 with connected inputs (with the possible exception of the system 102-2, depending on the particular embodiment), are notified that their input 106 has changed by calling their virtual method respondToInputChange( ). At that point those systems 102 have the option of obtaining read access to the new value of their connected inputs 106.

Once all tSystems 102 with connected inputs have been called with respondToInputChange( ), the destructor of the smart pointer exits, at which point output 104 of tSystem 102-2 again becomes available for any subsequent mutating operations. Thus, one output 106 may mutate input 104 at a time. Thus, outputs 106 are granted read access to input 104 before the change is made and after the change is made and can determine what changes occurred because other mutations do not happen during this time in one embodiment.

Accordingly, multiple tInputs 106 are notified of a change to a mutable input that is connected to tOutput 104. This may be important because changes to tInput 106 may affect tOutput 104 and thus may affect tInputs 106-2 and 106-3 that are connected to tOutput 104. The notification allows a user to see what was changed.

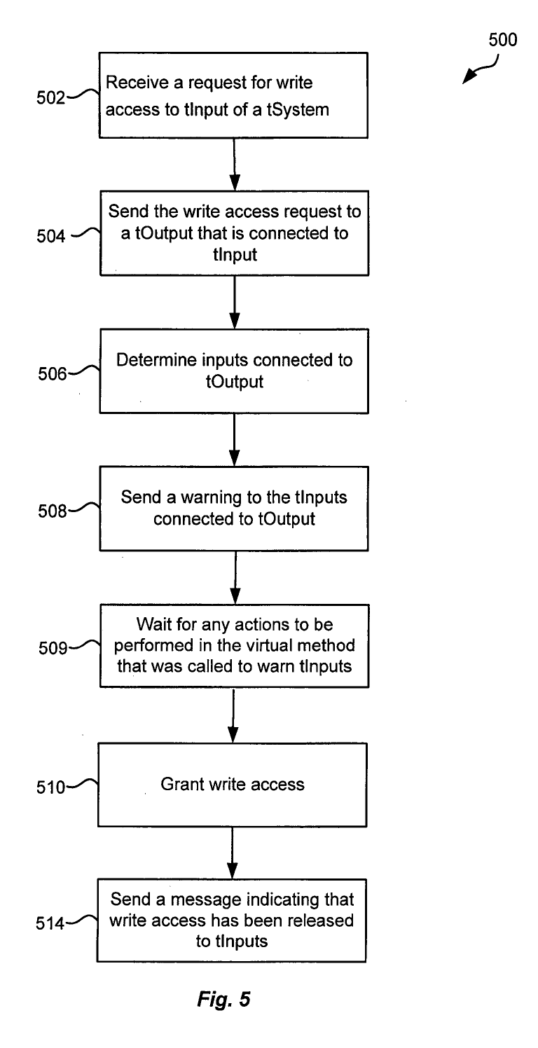

FIG. 5 depicts a simplified flowchart 500 of a method for modifying inputs according to one embodiment. Step 502 receives a request for write access to tInput 106 of a tSystem 102. For example, tSystem 102-2 may come to a point in its logic where it needs to modify its input 106.

Step 504 sends the write access request to a tOutput 104 that is connected to tInput 106-1. Step 506 determines inputs connected to tOutput 104. For example, tInput 106-2 may be determined. Step 508 then sends a warning to the tInputs 106 connected to tOutput 104. This alerts tInput 106-2 and any other inputs that write access has been granted and gives tSystems 102 the chance to read the value of output 104.

Step 509 waits for any actions to be performed in the virtual method that was called to warn tInputs 106. Step 510 then grants write access and tSystem 102 may then modify tInput 106. When write access is released, step 512 then sends a message indicating that write access has been released to tInputs 106-2 and 106-3. This alerts tInput 106-2 and any other inputs that write access has been released and gives tSystems 102 the chance to read the value of output 104.

The various features provide a general purpose functionality that includes allowing dynamic changes to structure. Inputs, outputs, and subsystems can be added and deleted and input-out connections can be made and broken at runtime. Dynamic changes to behavior are achieved via code generation, compile, dynamic linking, and swapping in new component in place of the old. The changes that connections and systems may affect inputs 104 and thus reliable signaling should be provided to warn and notify outputs 106 connected to inputs. For example, if an input 104 is initially connected to one tVariable, e.g. output 106-1, but then that connection is broken and it is then reconnected to some other tVariable, e.g. output 106-2, that would generally mean that the value of input 104 would change, even though the values of both output 106-1 and output 106-2 may have remained constant. Similarly, if the value of a given output 106 is computed by some function, and the implementation of that function is modified, the ‘official’ value of that output would change immediately, even if the new value is not computed at that time. In order to ensure correct change-signaling all such changes must be signaled by warnings-before and notifications-after.

A command-based interface is provided with support for undo-redo. All mutating operations on objects are typically carried out via commands, which can be undone and redone, and recorded in command histories and command scripts, which can be applied to different (but sufficiently similar) objects. This also makes it straightforward to implement APIs for use from other tools, e.g. Matlab™, Mathematica™, PV-Wave/IDL, Python™, Perl, DOS, Unix, etc.

In one embodiment, integrated support for connections crossing containership boundaries is provided. A pair of local proxies is used, one in each local scope, that is analogous to the usual OOP solution for interprocess communication to record each connection.

Type-specific info such as class name, base classes, data members, and member functions are provided for objects and values returned by tVariable, which can be of any OOP type. Runtime access to data members and member functions is provided. On request, any tObject will provide a selfRep—a tVariable whose value is defined by the state of that object. As with all tVariables, a selfRep will send a warning before and a notification after each discrete change to its value, the tObject. Whenever possible a copy of the command causing the change is also sent. Each time a command is applied to a sub-object of a given tObject the occurrence is trapped and a warning is sent via the selfRep, to be followed by a notification. A copy of the command is sent with each, but in order for the command to be interpreted properly the correct context is specified, as defined by the relative path from the selfRep'd object to the given sub-object.

By using the design approaches and features described herein, it is possible to achieve a software development framework having flexibility and extensibility, and strong integrated support for modeling and simulation. Note specific features may be practiced or implemented individually, as feasible or as desired. That is, in other embodiments, it is not necessary to have all of the described features, characteristics or details to obtain advantages or suitable performance.

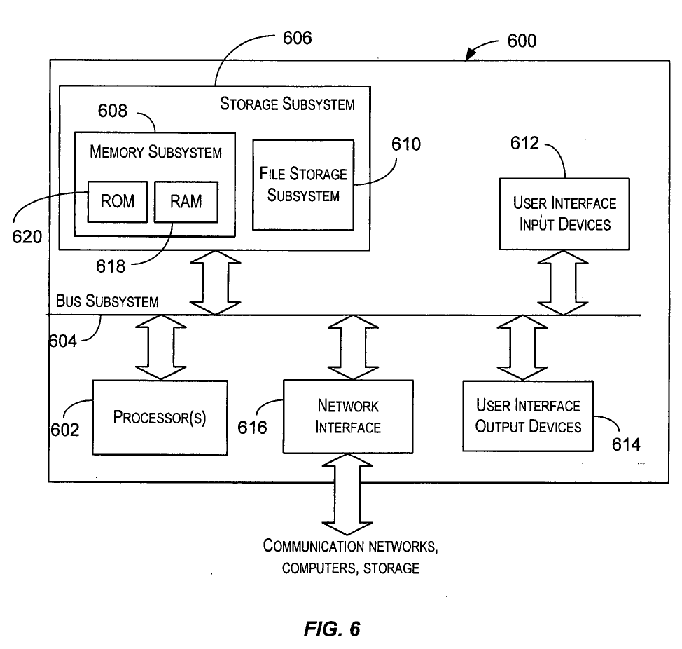

FIG. 6 is a simplified block diagram of a computer system 600 according to an embodiment of the present invention. Particular embodiments may be implemented using computer system 600. As shown in FIG. 6, computer system 600 includes at least one processor 602, which communicates with a number of peripheral devices via a bus subsystem 604. These peripheral devices may include a storage subsystem 606, comprising a memory subsystem 608 and a file storage subsystem 610, user interface input devices 612, user interface output devices 614, and a network interface subsystem 616. The input and output devices allow user interaction with computer system 600. A user may be a human user, a device, a process, another computer, or the like. Network interface subsystem 616 provides an interface to other computer systems and communication networks.

Bus subsystem 604 provides a mechanism for letting the various components and subsystems of computer system 600 communicate with each other as intended. The various subsystems and components of computer system 600 need not be at the same physical location but may be distributed at various locations within a network. Although bus subsystem 604 is shown schematically as a single bus, alternative embodiments of the bus subsystem may utilize multiple busses.

User interface input devices 612 may include a remote control, a keyboard, pointing devices, a mouse, trackball, touchpad, a graphics tablet, a scanner, a barcode scanner, a touchscreen incorporated into the display, audio input devices such as voice recognition systems, microphones, and other types of input devices. In general, use of the term “input device” is intended to include all possible types of devices and ways to input information using computer system 600.

User interface output devices 614 may include a display subsystem, a printer, a fax machine, or non-visual displays such as audio output devices. The display subsystem may be a cathode ray tube (CRT), a flat-panel device such as a liquid crystal display (LCD), a projection device, or the like. The display subsystem may also provide non-visual display such as via audio output devices. In general, use of the term “output device” is intended to include all possible types of devices and ways to output information from computer system 600.

Storage subsystem 606 may be configured to store the basic programming and data constructs that provide the functionality of the computer system and of the present invention. For example, according to an embodiment, software modules implementing the functionality of the present invention may be stored in storage subsystem 606. For example, modules implementing the functionality shown on interface 100 may be provided. These software modules may be executed by processor(s) 602. In a distributed environment, the software modules may be stored on a plurality of computer systems and executed by processors of the plurality of computer systems. Storage subsystem 606 may also provide a repository for storing various databases that may be used by the present invention. Storage subsystem 606 may comprise memory subsystem 608 and file storage subsystem 610.

Memory subsystem 608 may include a number of memories including a main random access memory (RAM) 618 for storage of instructions and data during program execution and a read only memory (ROM) 620 in which fixed instructions are stored. File storage subsystem 610 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media. One or more of the drives may be located at remote locations on other connected computers.

Computer system 600 itself can be of varying types including a personal computer, a portable computer, a workstation, a computer terminal, a network computer, a mainframe, a kiosk, a personal digital assistant (PDA), a communication device such as a cell phone, or any other data processing system. Server computers generally have more storage and processing capacity then client systems. Due to the ever-changing nature of computers and networks, the description of computer system 600 depicted in FIG. 6 is intended only as a specific example for purposes of illustrating the preferred embodiment of the computer system. Many other configurations of a computer system are possible having more or fewer components than the computer system depicted in FIG. 6.

Table I, below, shows a list of source code files provided on a CD-ROM as a Source Code Appendix for this application. The files are on one CD-ROM. Two identical copies of the CD-ROM are provided. The files were recorded using an International Business Machines (IBM) compatible personal computer running Microsoft™ Windows XP™ operating system and can be viewed with compatible equipment.

Although the description has been described with respect to particular embodiments thereof, these particular embodiments are merely illustrative, and not restrictive. For example, user interface features and details may be used independently of the framework discussed herein and may even be applied to other software systems or products.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method for providing reliable signaling for components in a component-based software framework, the method comprising:
determining when a change to an output for a first component occurs, the output being an object in the framework;
determining one or more inputs for a one or more components, the one or more inputs being connected to the output, the one or more inputs being one or more objects in the framework; and
notifying the one or more inputs connected to the output when the change has been completed, wherein the one or more inputs can reliably determine the change that was made.

2. The method of claim 1, wherein determining when the change to the output comprises determining when write access is requested for the output.

3. The method of claim 2, wherein notifying the one or more inputs comprises:
determining when the write access is released; and
notifying the one or more inputs that the write access has been released.

4. The method of claim 1, further comprising:
warning the one or more components that a change has been requested to the output; and
allowing read access to the output before the change is made.

5. The method of claim 1, wherein the change occurs because one of the one or more inputs is changing thereby affecting a change to the output connected to it.

6. The method of claim 1, further comprising:
setting a smart pointer for accessing the output, wherein the smart pointer is used to change the output;
receiving notification that the smart pointer has been released; and
determining that the change has been completed when the smart pointer has been released.

7. The method of claim 1, further comprising performing a call to an input warning virtual method, wherein the output can respond to the input warning virtual method to read a value of the output before the change is made.

8. The method of claim 1, further comprising performing a call to an input change virtual method after the change is made, wherein the output can respond to the input change virtual method to read a value of the output after the change is made, wherein any other changes cannot be made to the output until the virtual method returns.

9. The method of claim 1, wherein the output and one or more inputs are mutable.

10. The method of claim 1, wherein the one or more inputs comprise a plurality of inputs and the output comprises a plurality of outputs.

11. The method of claim 1, further comprising allowing recallability in determining changes that were made previously to the output.

12. The method of claim 1, further comprising:
determining a modification to first component or the one or more components;
determining one or more inputs for a one or more components, the one or more inputs being connected to the output, the one or more inputs being one or more objects in the framework;
warning the one or more inputs connected to the output that a modification has been requested, wherein the one or more inputs can reliably determine a value for the output before the modification; and
notifying the one or more inputs connected to the output when the modification has been completed, wherein the one or more inputs can reliably determine the change that was made.

13. The method of claim 1, further comprising sending a copy of a command to the one or more inputs, the command causing the change to the output.

14. The method of claim 14, wherein a variable to the input is requested, wherein the one or more outputs are warned and notified about the request for the variable.

15. A method for providing reliable signaling for components in a component-based software framework, the method comprising:
receiving a call to an input warning virtual method indicating write access to an output for a first system is requested, the output being connected to an input to a second system, wherein the second system can respond to the input warning virtual method to read a value of the output before a change is made; and
receiving a call to an input change virtual method after the change is made, wherein the second system can respond to the input change virtual method to read a value of the output after the change is made, wherein any other changes cannot be made to the output until the virtual method returns.

16. The method of claim 15, further comprising:
requesting read access to the output in the input warning virtual method;
receiving a value for the output before the change is made.

17. The method of claim 15, wherein the first system ensures that the value for the output is up to date.

18. The method of claim 15, further comprising:
requesting read access to the output in the input change virtual method; and
receiving a value for the output after the change is made.

19. A method for providing reliable signaling for components in a component-based software framework, the method comprising:
determining when a discrete change to the value of a variable occurs, the variable being an object in the framework used to represent a time-varying quantity;
determining one or more inputs of one or more components that are connected to the variable, the one or more inputs and one or more components being objects in the framework, and one or more connections between the variable and the one or more inputs defining relationships between the variable and the connected one or more inputs such that whenever the value of the variable changes the values of the inputs change are affected; and
notifying the one or more components with one or more inputs connected to that variable when the change is completed, wherein the notification is provided whereby the one or more components can reliably obtain the new value of the one or more inputs, reflecting the effect of the change just completed, and not reflecting the effects of any subsequent change.

20. The method of claim 19, further comprising:
warning the one or more components of the change before the change begins, wherein a mechanism is provided whereby the one or more components can reliably obtain the value of the input just prior to the change.

21. The method of claim 19, further comprising obtaining access to past values of an input in the one or more inputs at specified moments in virtual time before or after the change.

22. The method of claim 19, further comprising:
detecting when write access to its value is requested and obtained to indicate the beginning of the change; and
detecting when the write access is released to indicate the end of the change.

23. The method of claim 22, wherein the write access to the value is achieved using a smart pointer, wherein an object in the framework is used to provide temporary write access to the value of the variable.

24. The method of claim 19, wherein the variable is an output of a system, and the change to the value of the output is signaled, but the change to the value is not computed until it is requested, the method further comprising:
receiving a request for the value of the variable;
determining whether the value of the variable is up to date;
updating the value if it is not up to date; and
returning the up-to-date value.

25. The method of claim 19, wherein an input in the one or more inputs can represent a plurality of variables that can change independently of one another, and where each notification specifies which of those variables has changed.

26. The method of claim 19, wherein the change to the variable is caused by applying a command to it, wherein the notification provided includes information describing the command.

27. The method of claim 19, wherein the value of the variable is defined by the instantaneous state of an object in the framework, where the state of that object may be changed by applying a command to it.

28. The method of claim 19, wherein the value of the input varies continuously with respect to time, the method further comprising:
receiving notifications for discrete changes, wherein the component cannot assume that the value of its input will have remained constant in between discrete changes if any virtual time has elapsed.

29. A computer readable storage medium comprising software for execution by one or more processors, the software when executed operable to:
determine when a discrete change to the value of a variable occurs, the variable being an object in the framework used to represent a time-varying quantity;
determine one or more inputs of one or more components that are connected to the variable, the one or more inputs and one or more components being objects in the framework, and one or more connections between the variable and the one or more inputs defining relationships between the variable and the connected one or more inputs such that whenever the value of the variable changes the values of the inputs change are affected; and
notify the one or more components with one or more inputs connected to that variable when the change is completed, wherein the notification is provided whereby the one or more components can reliably obtain the new value of the one or more inputs, reflecting the effect of the change just completed, and not reflecting the effects of any subsequent change.

30. The computer readable storage medium of claim 29, wherein the software when executed is further operable to:
warn the one or more components of the change before the change begins, wherein a mechanism is provided whereby the one or more components can reliably obtain the value of the input just prior to the change.

31. The computer readable storage medium of claim 29, wherein the software when executed is further operable to obtain access to past values of an input in the one or more inputs at specified moments in virtual time before or after the change.

32. The computer readable storage medium of claim 29, wherein the software when executed is further operable to:
detect when write access to its value is requested and obtained to indicate the beginning of the change; and
detect when the write access is released to indicate the end of the change.

33. The computer readable storage medium of claim 32, wherein the write access to the value is achieved using a smart pointer, wherein an object in the framework is used to provide temporary write access to the value of the variable.

34. The computer readable storage medium of claim 29, wherein the variable is an output of a system, and the change to the value of the output is signaled, but the change to the value is not computed until it is requested, wherein the software when executed is further operable to:
receive a request for the value of the variable;
determine whether the value of the variable is up to date;
update the value if it is not up to date; and
return the up-to-date value.

35. The computer readable storage medium of claim 29, wherein an input in the one or more inputs can represent a plurality of variables that can change independently of one another, and where each notification specifies which of those variables has changed.

36. The computer readable storage medium of claim 29, wherein the change to the variable is caused by applying a command to it, wherein the notification provided includes information describing the command.

37. The computer readable storage medium of claim 29, wherein the value of the variable is defined by the instantaneous state of an object in the framework, where the state of that object may be changed by applying a command to it.

38. The computer readable storage medium of claim 29, wherein the value of the input varies continuously with respect to time, wherein the software when executed is further operable to:
receive notifications for discrete changes, wherein the component cannot assume that the value of its input will have remained constant in between discrete changes if any virtual time has elapsed.
